(19) United States
(12) Patent Application Publication
(10) Pub. No.: US 2002/0154813 A1
(43) Pub. Date: Oct. 24, 2002

(54) Digital image sensor compensation

(76) Inventors: George E. Stevenson, Seattle, WA (US); Leslie Alan Leech, Kowloon (HK); James R.W. Phillips, Bellevue, WA (US)

Correspondence Address: BLACK LOWE & GRAHAM, 816 SECOND AVE., SEATTLE, WA, 98104, US

(21) Appl. No.: 09/839,530

(22) Filed: Apr. 19, 2001

(51) Int. Cl. G06K 9/00

(52) U.S. Cl. 382/167

(57) ABSTRACT

A system, method and computer program product for profiling a digital image sensor at production time and editing images generated by the digital image sensor according to the profile. The method exposes a digital image sensor with an array of photosites to a plurality of test cards, compares the image generated by one or more of the photosites in the array, based on the exposure to each test card, to an expected image signal result for each test card, and generates a profile of the digital image sensor based on the comparison. After the digital image sensor records an image, a processor internal or external to the digital image sensor adjusts the recorded image according to the stored profile and a compensation algorithm.

### BACKGROUND OF THE INVENTION

Digital imaging devices, such as a charge-coupled-device (CCD) or a Complementary Metal Oxide Semiconductor (CMOS) device, generate digital signals representative of an image they are exposed to. These devices contain an array of light detecting photosites which accumulate charge depending on the light energy projected onto them. The charges are measured in signal processing circuits to produce a digital data signal for each image pixel of a display device.

During manufacturing or use some photosites are flawed and thereby produce a defective image signal. There exist a number of post production methods for determining flaws and making adjustments to the images produced by the image sensor. These methods are preformed by software on an image processing computer that receives the images from the image sensor. They focus on finding flaws in the produced image. Therefore, when the same image sensor is coupled to a different image processing computer, the image cannot be fixed unless that different image processing computer includes the same software. Providing this software on every image processing computer is costly and impractical.

Therefore, there exists a need to produce an image sensor device with predetermined information regarding the status of photosites in order to make processing images generated by the sensor device more efficient.

### SUMMARY OF THE INVENTION

The present invention provides a method and computer program product for profiling a digital image sensor at production time and editing images generated by the digital image sensor according to the profile. The method includes exposing a digital image sensor with an array of photosites to a test card, comparing an image signal generated by one or more of the photosites in the array, based on the exposure to the test card, to an expected image signal result for the one or more of the photosites for the test card, and generating a profile of the digital image sensor based on the comparison. The method is repeated for a plurality of different test cards. After the digital image sensor records an image, a processor internal or external to the digital image sensor adjusts the recorded image according to the stored profile and a compensation algorithm.

As will be readily appreciated from the foregoing summary, the invention provides a system, method, and computer program product for efficiently and effectively determining the status of a digital image sensor (camera) and producing quality images according to the determined status.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIGS. 1 and 2 are block diagrams of components of the present invention;

FIGS. 3-5 are flow diagrams of a method for executing the present invention; and

FIGS. 6A-C and 7 are an example of the present invention.

### DETAILED DESCRIPTION OF THE PREFERRED EMBODIMENT

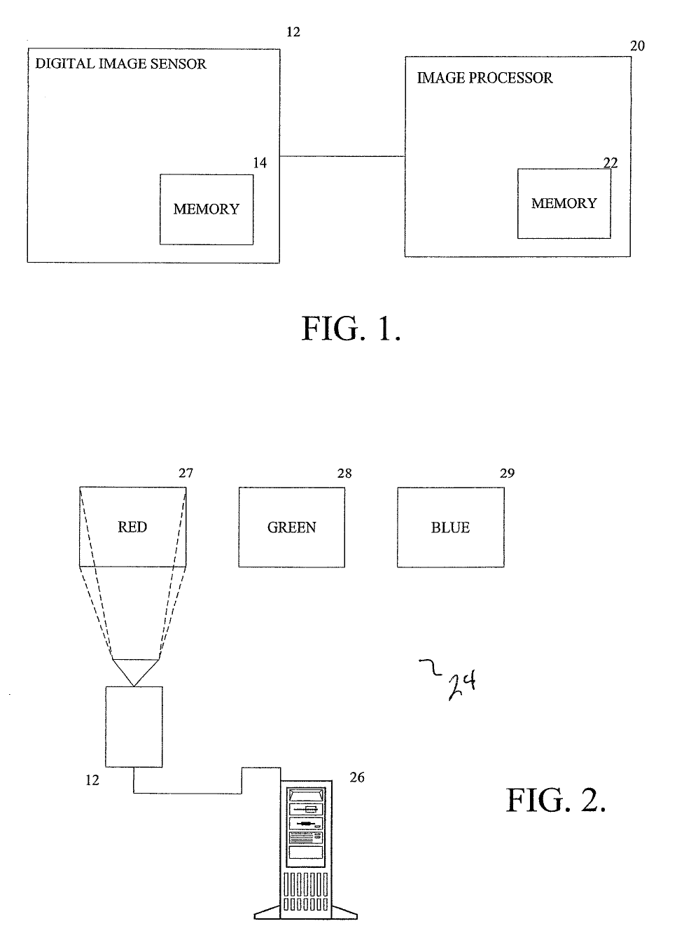

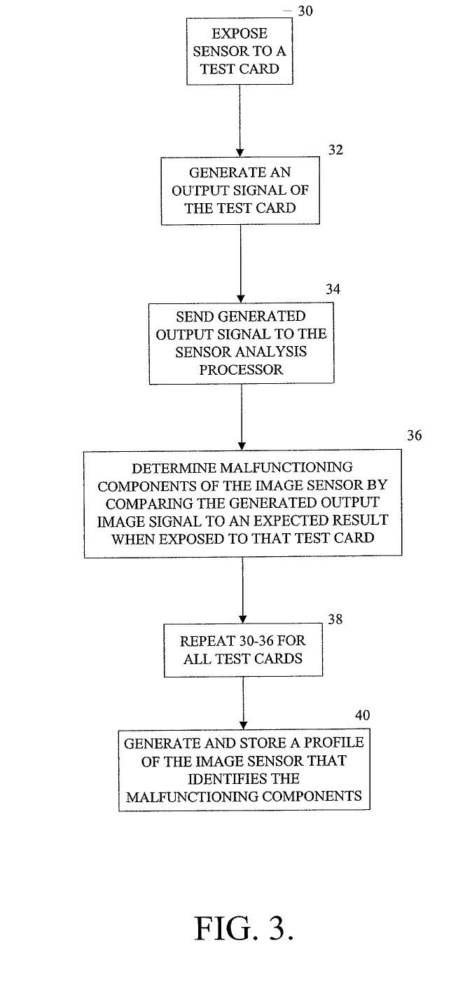

As shown in FIG. 1, a first embodiment of the present invention is a system 10 that includes a digital image sensor 12 with internal memory 14. The digital image sensor 12 is coupled to an image processor 20 with internal processor memory 22. The digital image sensor 12, for example a CCD or CMOS digital video camera, is coupled to the image processor 20 when still or video images recorded by the sensor 12 are to be downloaded from the sensor 12 and processed. Stored within the digital image sensor memory 14 is a profile of sensor 12. The profile identifies the operable and inoperable photosites of the digital image sensor 12. The process for determining the sensor's profile is described below with reference to FIG. 3.

Stored within the image processor memory 22 is a compensation algorithm. An example compensation algorithm is described in more detail below with reference to FIG. 5. In an alternate embodiment, the compensation algorithm may be stored within the digital image sensor memory 14, if it is necessary to convert the digital signal generated by the sensor 12 into an analog equivalent for transmission to a display device or other analog device, such as a VCR. The image processor 20 is preferably a user's personal computer that receives the image as recorded by the digital image sensor 12 and processes the recorded image according to the compensation algorithm. The compensation algorithm uses the sensor's profile and is independent of the sensor 12; therefore the compensation algorithm is the same for all image processors.

FIG. 2 illustrates an example system 24 showing components used during the manufacturing of a digital image sensor. The sensor 12 is coupled to a sensor analysis processor 26 during the final stages of sensor production. The system 24 also includes a series of test cards 27-29. In this example, the digital image sensor 12 includes three photosites for representing each pixel. The three photosites are red, green, and blue. The test cards are a red test card 27, a green test card 28, and a blue test card 29. The sensor analysis processor 26 receives the signals generated by each corresponding photosite of the digital image sensor 12 when exposed to each of the test cards 27-29 and generates a profile according to what the digital image sensor 12 should be recording when exposed to each of the test cards. The process performed by system 24 is described in more detail in FIG. 3 below.

The sensor 12 generates an output image signal representing a value from each photosite that is to be reproduced by correspondingly colored pixel elements on a display device that is coupled to the image processor 20. The correspondence between the pixels of a sensor and the pixels of a display device is not always an exact 1:1 correspondence. If it is not a 1:1 correspondence, the image processor 20 adjusts the image recorded by the sensor 12 in order to be properly displayed over the display device.

FIG. 3 illustrates the preferred process for generating a profile of the operative and inoperative photosites of digital image sensor 12 as performed by the system 24 shown in FIG. 2. First, at block 30, the array of photosites of the digital image sensor 12 are exposed one-by-one to a plurality of test cards. The type of tests cards used are dependent upon the configuration of the digital image sensor 12. For example, a black and white digital image sensor only needs two test cards, one black in one white. For a digital image sensor that reads color, more specifically red, green, and blue, the test cards are one red, one green and one blue. Though these choices are preferred, other color combinations would also be used in either case to produce an acceptable profile. Next, at block 32, the digital image sensor 12 generates an output signal after exposure to each of the test cards. At block 34, the generated output signal is sent to the digital image sensor analysis processor 26. The sensor analysis processor 26, at block 36, determines whether there are any malfunctioning components (photosites) within the digital image sensor 12 by comparing the generated output image signal to expected result when exposed to a particular test card. For example, if the test card is a red test card, the expected value is a one out of a scale of 0-1, 1 being full on, 0 being off, for the red photosites of each pixel. In this example, each pixel of the sensor 12 includes three photosites, one that reacts when exposed to green light, a second that registers blue light and a third that registers red light. Any photosite generating a value different than a predetermined threshold from the expected value is determined as malfunctioning. The threshold value can vary, but is preferably set closer to the expected value (e.g., 1) than the value that would correspond to a malfunction (e.g., 0).

At block 38, the steps in blocks 30-36 are repeated until all the test cards have been tested. After all the test cards have been analyzed, at block 40, the sensor analysis processor 20 generates a profile of the operative and inoperative photosites of the digital image sensor 12. The sensor analysis processor 26 then stores the generated profile in non-volatile memory 14 within the digital image sensor 12 for later use in the compensation algorithm.

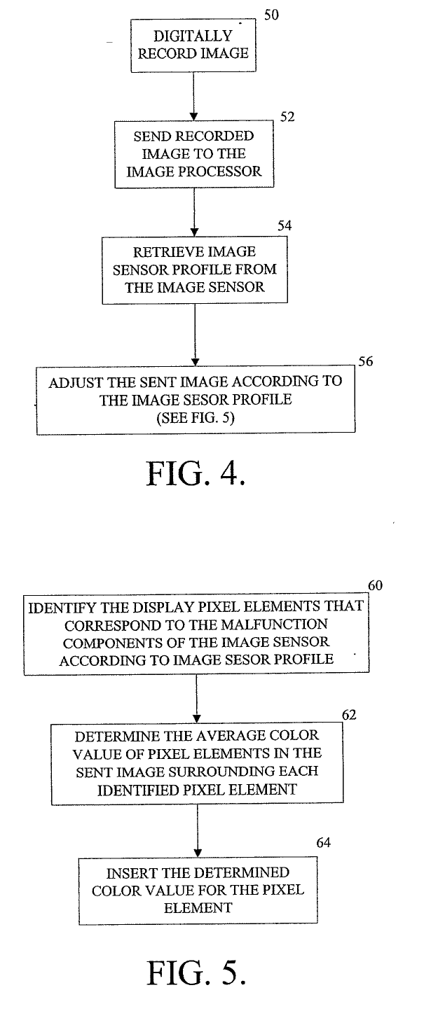

FIG. 4 illustrates a process performed by the digital image sensor 12 when generating images postproduction. First, at block 50, the digital image sensor 12 records an image, single image or a video image. Next, at block 52, the recorded image is sent to the image processor 20. At block 54, the image sensor profile is retrieved from the image sensor 12 by the image processor 20 (or sent by the sensor 12 to the image processor 20), preferably when the image processor 20 is initially connected to the digital image sensor 12. Once received, the processor 20 now has a map of all pixels corresponding to inoperative photosites that do not respond to a particular color or shade. Next, at block 56, the image processor 20 adjusts the recorded image according to the image sensor profile and the compensation algorithm stored within the processor memory 22. An example compensation algorithm is described more detail below with respect to FIG. 5.

FIG. 5 shows one embodiment of the compensation algorithm. First, at block 60, the image processor 20 executing the compensation algorithm, preferably as a software program, identifies pixel elements of the recorded image that are to be displayed that correspond to malfunctioning photosites of the image sensor according to the image sensor profile. Next, at block 60, The processor 20 determines the average color value of pixel elements that surround each identified pixel element. At block 64, according to the algorithm the processor 20 inserts the determined average color value of the surrounding pixel elements as the value of the pixel element for the corresponding malfunctioning photosite.

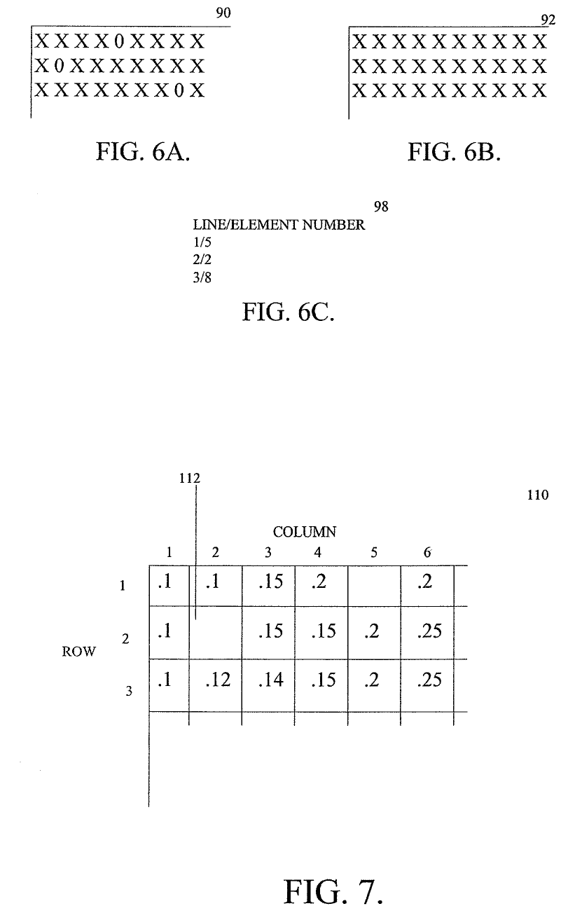

FIGS. 6A-C illustrate an example generation of a sensor's profile after exposure to a single test card. FIG. 6A illustrates a portion 90 of the image signal generated after exposure to a first test card. FIG. 6B illustrates an expected portion 92 of the image signal that the image sensor 12 should be recording. Upon comparing the portion 90 to the expected portion 92 a profile 98 is generated that identifies the malfunctioning photosites. For example, the portion 90 includes malfunctioning photosites at locations row 1 column 5, row 2 column 2 and row 3 column 8. The malfunctioning photosites information is stored as part of the sensor's profile. While the profile is depicted in FIG. 6C as a listing of row and column numbers corresponding to malfunctioning photosites, the profile may be stored in other ways, such as a table of the type shown in FIG. 6A.

FIG. 7 illustrates a portion 110 of a frame of an image generated by the digital image sensor 12. In image portion 110, pixel element 112 at row 2 column 2 was previously identified as having or producing a malfunctioning result, see FIG. 6C. The image processor 20, according to the compensation algorithm, determines that this pixel element 112 is malfunctioning, in accordance with the sensor profile 98. To compensate for the error, the method samples the values of pixel elements surrounding the malfunctioning pixel element 112, takes the average of those values and inserts that average into pixel element 112.

0.1+0.1+0.15+0.1+0.15+0.1+0.12+0.14=0.96/8=0.12 (1)

The inserted value is 0.12, see equation (1) above. This is repeated for each base color, for example red, green and blue for an RGB color display and then combined to present a final adjusted image.

While the preferred embodiment of the invention has been illustrated and described, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A method comprising:
a) exposing a digital image sensor comprising an array of photosites to a test card;
b) comparing an image signal generated by one or more of the photosites in the array, based on the exposure to the test card, to a threshold value; and
c) generating a profile of the digital image sensor based on the comparison.

2. The method of claim 1, wherein a generated profile comprises status information of the photosites in the array.

3. The method of claim 2, further comprising storing the generated profile in memory associated with the digital image sensor.

4. The method of claim 3, further comprising repeating the steps of exposing and comparing for one or more additional test cards.

5. The method of claim 4, wherein the digital image sensor is a monochrome device and the test cards are a shade value.

6. The method of claim 4, wherein the digital image sensor is a color device and the test cards are different base colors.

7. The method of claim 6, wherein the test cards comprise a red test card, a green test card, and a blue test card.

8. The method of claim 4, further comprising:
recording an image by the digital image sensor; and
adjusting the recorded image according to the stored profile and a compensation algorithm.

9. The method of claim 8, wherein adjusting the value assigned to a malfunctioning photosite interpolates the values of adjacent photosites.

10. The method of claim 8, wherein the status information for a photosite indicates if the photosite is inoperable, and
wherein adjusting comprises determining an average value of pixels surrounding a pixel corresponding to a photosite determined to be inoperable, and assigning the average value to the pixel that corresponds to the inoperable photosite.

11. A computer program product comprising:
a first component for receiving an image signal generated by a digital image sensor comprising an array of photosites after exposure to a test card;
a second component for comparing the received image signal to an expected image signal result for the one or more of the photosites for the test card; and
a third component for generating a profile of the digital image sensor based on the comparison.

12. The product of claim 11, wherein a generated profile comprises status information of the photosites in the array.

13. The product of claim 12, further comprising a fourth component for storing the generated profile in memory of the digital image sensor.

14. The product of claim 13, further comprising a repeating component for repeating the function performed by the first through fourth components for different test cards.

15. A computer program product comprising:
a first component for recording an image by a digital image sensor comprising an array of photosites, wherein the digital image sensor includes a profile of the operable status of the photosites;
a second component for adjusting the recorded image according to the profile and a compensation algorithm.

16. The product of claim 15, wherein the second component comprises determining an average value of pixels surrounding a pixel corresponding to a photosite with inoperable status information, and entering the determined average value as the value for the pixel that corresponds to the inoperable photosite.

17. A system comprising:
one or more test cards;
a digital image sensor comprising an array of photosites;
an image processor for comparing an image signal generated by one or more of the photosites in the array of the digital image sensor, based on exposure of the sensor to one of the one or more test cards, to a threshold value, and for generating a profile of the digital image sensor based on the comparison.

18. The system of claim 17, wherein a generated profile comprises status information of the photosites in the array.

19. The system of claim 18, wherein the sensor further comprises memory for storing the generated profile.

20. The system of claim 19, wherein the image processor generates a profile by comparing an image signal generated by all the photosites when exposed to all the test cards.

21. The system of claim 20, wherein the digital image sensor is a monochrome device and the test cards are a shade value.

22. The system of claim 20, wherein the digital image sensor is a color device and the test cards are different base colors.

23. The system of claim 22, wherein the test cards comprise a red test card, a green test card, and a blue test card.

24. The system of claim 20, wherein the digital image sensor records an image, and adjusts the recorded image according to the stored profile and a compensation algorithm.

25. The system of claim 24, wherein the digital image sensor adjusts by interpolating the value assigned to a malfunctioning photosite by interpolating the values of adjacent photosites.

26. The system of claim 24, wherein the status information for a photosite indicates if the photosite is inoperable, and
wherein the digital image sensor adjusts by determining an average value of pixels surrounding a pixel corresponding to a photosite determined to be inoperable, and by assigning the average value to the pixel that corresponds to the inoperable photosite.
